(19) United States
(12) Patent Application Publication
(10) Pub. No.: US 2009/0048921 A1
(43) Pub. Date: Feb. 19, 2009

(54) User content in advertisements

(75) Inventors: Lance Tokuda, Foster City, CA (US); Peter Louis, Foster City, CA (US)

Correspondence Address: Raj Abhyanker, LLP;c/o Intellevate, P.O. Box 52050, Minneapolis, MN, 55402, US

(73) Assignee: NetPickle, Inc.

(21) Appl. No.: 11/893,558

(22) Filed: Aug. 15, 2007

(51) Int. Cl. G06Q 30/00

(52) U.S. Cl. 705/14

(57) ABSTRACT

A method, apparatus, and system of user content in advertisements are disclosed. In one embodiment, a method of advertising to a user includes receiving user content from the user, sending the user content to an ad unit, processing the user content (e.g., through applying a facial recognition algorithm to an image), incorporating the user content into an advertisement and displaying the advertisement (e.g., on a website) to the user. The method may further include storing the user content in a server. The method may further include generating the advertisement based on the processing of the user content. In another embodiment, a system for advertising to a user includes a server configured to receive user content from the user, and an ad unit configured to process the user content, incorporate the user content into an advertisement, and transmit the advertisement to the user.

### FIELD OF TECHNOLOGY

This disclosure relates generally to the technical fields of communications and, in one example embodiment, to a method, apparatus, and system of user content in advertisements.

### BACKGROUND

Online advertising utilizes Internet-based mechanisms to transmit advertisements to Internet users. Through the use of keyword searches, browsing, and/or categories, businesses may be able to target and/or present information to potential customers more effectively than traditional means of advertisement, such as television, radio, and/or publications. Similarly, the potential customers may be able to better locate products and/or services using searching, browsing, and/or content-sharing utilities on the Internet. Furthermore, businesses and/or customers may interact on the Internet through newsletters, messaging, and/or web-based promotions.

The online advertisements may often be delivered using search engine advertising, desktop advertising, online advertising directories, advertising networks, and/or email advertising. The online advertising may appear as text, static images, and/or multimedia, such as Flash™ (Flash is a registered trademark of the Adobe Corporation) and/or streaming audio, and/or video. Types of the online advertisements may include banner ads, which are displayed on websites, web applications, and/or emails, interstitial ads which are displayed on a website before requested content, floating ads which appear above the content, pop-up ads which appear in a new window, and/or mobile ads which are sent as text and/or multimedia messages to mobile phones.

The online advertisements may be purchased through one of several payment conventions. Cost per thousand (CPM) advertising may allow an advertiser to pay for displaying the ad to 1,000 people, which may be estimated by the number of page views. For example, if a website sells banner ads for $20 CPM, an advertiser would pay $200 for showing the banner 10,000 times. Cost per click (CPC) advertising charges an advertiser for the number of user clicks on an advertisement, rather than the number of times the advertisement is displayed and/or viewed. CPC advertising provides an incentive for ad publishers to target the ads correctly (e.g., by keyword or context), since payment is based on a viewer's response to the ad. Cost per action (CPA) advertising charges an advertiser for each user that completes a transaction, such as a purchase, subscription, and/or completion of a form. CPA may be considered the optimal form of buying online advertising from an advertiser's point of view.

Contextual advertising methods may be increasingly used to attract users to online advertisements, particularly in the CPC and the CPA advertising. For example, the users may only display advertisements that correspond to a keyword search or the content of the site the user is browsing. Similarly, hyperlinks may be embedded into articles by the advertisers. When a user clicks on a hyperlink in the article, the user is sent to an advertiser's website. Due to increase in the popularity of the online advertising and the Internet in general, new and/or innovative contextual ads may be demanded by both advertisers and ad publishers.

### SUMMARY

A method, apparatus, and system of user content in advertisements are disclosed. In one aspect, a method of advertising to a user includes receiving user content (e.g., may include a digital media) from the user, sending the user content to an ad unit, processing the user content (e.g., through applying a facial recognition algorithm to an image), incorporating the user content into an advertisement, and displaying the advertisement (e.g., on a website) to the user. The method may further include storing the user content in a server (e.g., the server may include a content hosting service). The method may also include generating the advertisement based on the processing of the user content.

In another aspect, a system for advertising to a user includes a server (e.g., the server may include a content hosting service) configured to receive user content (e.g., a digital media) from the user, and an ad unit configured to process (e.g., by applying a facial recognition algorithm to an image) the user content, incorporate the user content into an advertisement, and transmit the advertisement to the user. Furthermore, the server may be configured to store the user content. The ad unit may be further configured to generate the advertisement based on the processing of the user content. The system may further include a user interface including an upload module configured to obtain the user content from the user and an ad display module configured to display (e.g., on the website) the advertisement to the user.

In yet another aspect, a method of accessing a content hosting service includes selecting user content (e.g., a digital media), uploading the user content to a server associated with the content hosting service, accessing the user content using the content hosting service and receiving an advertisement incorporating the user content. In addition, the advertisement (e.g., displayed on the content hosting service) may be generated based on processing of the user content. Moreover, the user content may be processed by applying a facial recognition algorithm to an image.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram illustrating incorporation of user content into an advertisement, according to one embodiment.

FIG. 2 is a user interface view of a content hosting service associated with the server of FIG. 1, according to one embodiment.

FIG. 3 is a user interface view displaying advertisements incorporating user content on a website, according to one embodiment.

FIG. 4 is a flow chart of accessing the content hosting service of the server, according to one embodiment.

FIG. 5 is a flow chart of incorporating and displaying the user content in the advertisement, according to one embodiment.

FIG. 6 is a diagrammatic system view of a data processing system in which any of the embodiments disclosed herein may be performed, according to one embodiment.

FIG. 7 is a process flow of generating an advertisement associated with user content, according to one embodiment.

Other features of the present embodiments will be apparent from the accompanying drawings and from the detailed description that follows.

### DETAILED DESCRIPTION

A method, apparatus, and system of user content in advertisements are disclosed. In the following description, for the purposes of explanation, numerous specific details are set forth in order to provide a thorough understanding of the various embodiments. It will be evident, however to one skilled in the art that the various embodiments may be practiced without these specific details.

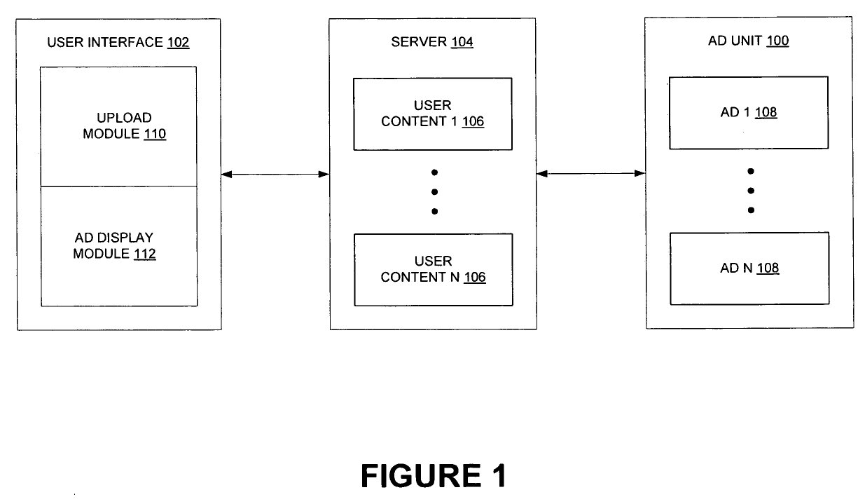

In one embodiment, a method of advertising to a user includes receiving user content (e.g., the user content 1-N 106 of FIG. 1) from the user, sending (e.g., through the server 104 of FIG. 1) the user content to an ad unit (e.g., the ad unit 100 of FIG. 1), processing the user content 1-N 106, incorporating the user content 1-N 106 into an advertisement (e.g., the ads 1-N 108 of FIG. 1), and displaying the advertisement 300 to the user.

In another embodiment, a system for advertising to a user includes a server (e.g., the server 104 of FIG. 1) configured to receive (e.g., through the user interface 102 of FIG. 1) user content 1-N 106 from the user and an ad unit (e.g., the ad unit 100 of FIG. 1) configured to process the user content 1-N 106, incorporate the user content 1-N 106 into an advertisement(s) 1-N 108, and transmit the advertisement(s) 1-N 108 to the user.

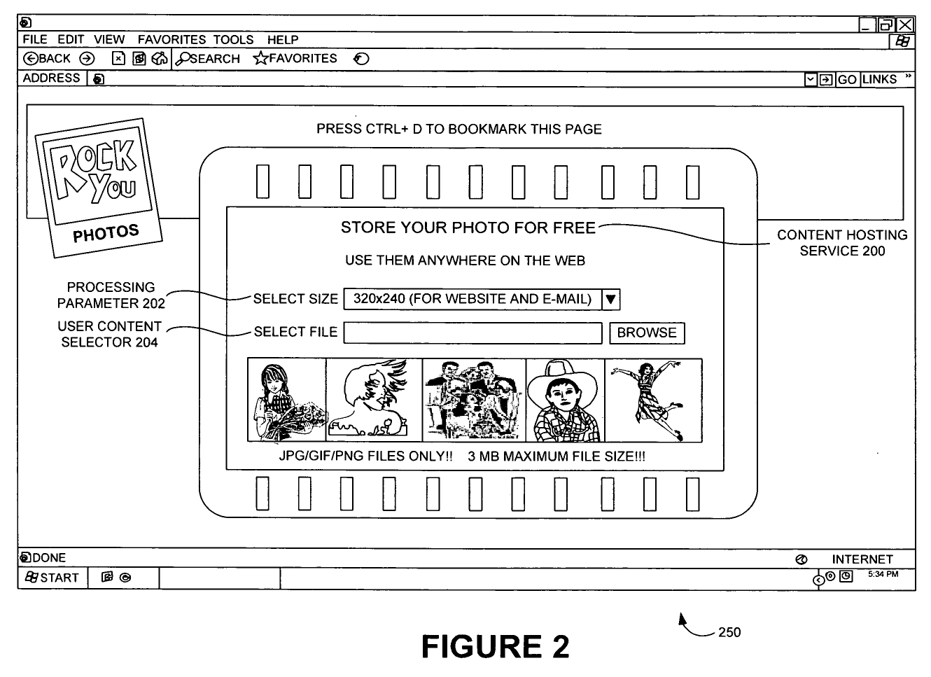

In yet another embodiment, a method of accessing a content hosting service (e.g., the content hosting service 200 of FIG. 2) includes selecting user content 1-N 106, uploading (e.g., using the upload module 110 of FIG. 1) the user content 1-N 106 to a server (e.g., the server 104 of FIG. 1) associated with the content hosting service 200, accessing the user content 1-N 106 using the content hosting service 200, and receiving an advertisement (e.g., the ads 1-N 108 of FIG. 1) incorporating the user content 1-N 106.

FIG. 1 is a block diagram illustrating incorporation of user content 1-N 106 into advertisements 1-N 108, according to one embodiment. Particularly, FIG. 1 illustrates an ad unit 100, a user interface 102, a server 104, the user content 1-N 106, the ads 1-N 108, an upload module 110, and an ad display module 112, according to one embodiment.

The ad unit 100 may generate advertisements 1-N 108 by processing the user content 1-N 106 received from the server 104. The user content 1-N 106 may be created by a user and uploaded to the server 104 through the user interface 102. In one example embodiment, a network connection (e.g., wired connection, wireless connection, etc.) may be used to upload user content 1-N 106 to the server 104 from the user interface 102. The user content 1-N 106 may include digital media such as text, graphics, animations, photographs, sound and/or video. In one embodiment, the user interface 102 allows the user to upload the user content 1-N 106 through the upload module 110 and/or view advertisements 1-N 108 through the ad display module 112. For example, the upload module 110 and ad display module 112 may be accessed through one or more websites. Additionally, the user interface 102 may be displayed using a web browser.

The server 104 may be a computer that stores and/or processes user content 1-N 106 received from the user. The server 104 may be accessed using one or more network connections. In one example embodiment, the server 104 includes a content hosting service (e.g., the content hosting service 200 of FIG. 2), such as a photo sharing service, video sharing service, web blog, social networking site, etc. For example, the content hosting service 200 may allow the user to share user content 1-N 106 with other users of the content hosting service 200. For example, the content hosting service 200 may allow the user to share pictures, videos, journal entries, etc. with other users of the content hosting service 200.

In one example embodiment, the user content 1-N 106 is transmitted from the server 104 to the ad unit 100. The user content 1-N 106 may be transmitted using a network connection. The ad unit 100 may reside on the same physical host as the server 104 and access the user content 1-N 106 using pointers to the user content 1-N 106. On the other hand, the ad unit 100 may reside on a separate machine and transmit and receive information to and from the server 104 using the network connection. In addition, the ad unit 100 may generate ads 1-N 108 by processing the user content 1-N 106 and/or incorporating the user content 1-N 107 into ads 1-N 108. The advertisement(s) 1-N 108 may include online advertisements such as banner ads, interstitial ads, floating ads, pop-up ads, mobile ads, etc.

In an example embodiment, the user content 1-N 106 and ads 1-N 108 are transmitted and/or received by the user on different devices. For example, the user may upload a photo (e.g., user content 1-N 106) to the server 104 using a laptop computer. An advertisement (e.g., ads 1-N 108) incorporating the photo may be generated by the ad unit 100 and transmitted to the user's mobile phone. Further, the ads 1-N 108 may be generated from the user content 1-N 106 in multiple ways. An ad (e.g., ads 1-N 108) may include one piece of user content 1-N 106, or multiple pieces of user content 1-N 106. Similarly, a piece of user content 1-N 106 may be used to generate one ad 1-N 108, multiple ads 1-N 108, or no ads at all. For example, one or more uploaded photos may be used to create a banner ad, streaming video ad, pop-up ad, and/or other types of advertisements.

In the example embodiment as illustrated in FIG. 1, the server 104 communicates with the user interface 102 and the ad unit 100 to receive the user content 1-N 106 from the user, incorporate the user content 1-N 106 stored in the server 104 into the advertisement(s) 1-N 108, and send the advertisement(s) 1-N 108 to the user. The user interface 102 includes the upload module 110 to enable the user to upload user content 1-N 106, and the ad display module 112 to allow the user to view the ads 1-N 108. The server 104 may store the user content 1-N 106, and/or may allow other users to access the user content 1-N 106. The ad unit 100 may then generate the advertisement(s) 1-N 108 from the user content 1-N 106.

The user content 1-N 106 (e.g., digital media) may be received (e.g., using the server 104 of FIG. 1) from the user and sent to the ad unit 100. The user content 1-N 106 may also be processed by either the server 104 or the ad unit 100. For example, an image may be processed by converting from one format to another, applying a facial recognition algorithm to the image, scaling or rotating the image, cropping the image, performing color processing on the image, etc. In addition, the user content 1-N 106 may be incorporated (e.g., using the ad unit 100 of FIG. 1) into the advertisement(s) 1-N 108 with or without processing. The advertisement(s) 1-N 108 may then be displayed (e.g., using the ad display module 112 of FIG. 1) to the user.

The user content 1-N 106 may be stored in the server 104 using the content hosting service 200. The advertisement(s) 1-N 108 may be generated (e.g., using the ad unit 100 of FIG. 1) based on the processing of the user content 1-N 106. The server 104 may be configured to receive and/or store the user content 1-N 106 from the user.

The ad unit 100 may be configured to process the user content 1-N 106 (e.g., by applying the facial recognition algorithm to the image), incorporate the user content 1-N 106 into the advertisement(s) 1-N 108, and transmit the advertisement(s) 1-N 108 to the user. The ad unit 100 may be further configured to generate the advertisement(s) 1-N 108 based on the processing of the user content 1-N 106. The upload module 110 of the user interface 102 may be configured to obtain the user content 1-N 106 from the user. The ad display module 112 of the user interface 102 may be configured to display the advertisement(s) 1-N 108 (e.g., may be displayed on the website) to the user.

FIG. 2 is a user interface view 250 of a content hosting service 200 associated with the server 104 of FIG. 1, according to one embodiment. Particularly, FIG. 2 illustrates the content hosting service 200, a processing parameter 202, and a user content selector 204, according to one embodiment.

The content hosting service 200 may be a fee-based, subscription-based, free or advertising-supported service that allows the user to store the user content 1-N 106 on the server 104. The content hosting service 200 may also enable the user to embed the user content 1-N 106 stored in the server 104 on different websites and/or share the user content 1-N 106 with other users. The processing parameter 202 may enable the user to specify how the user content 1-N 106 is processed. For example, the processing parameter 202 may allow the user to specify a file size for storing pictures on the content hosting service 200.

The file size may be indicated in bytes, kilobytes (KB), megabytes (MB) or gigabytes (GB). The user content selector 204 may enable the user to select and/or upload the user content 1-N 106 (e.g., images, audio, video, text, etc.) to the content hosting service 200. For example, the user content selector 204 may allow the user to browse for a photo on the user's computer and upload the photo to the content hosting service 200. The photo may then be scaled to the file size specified in the processing parameter 202 before being stored by the content hosting service 200.

In the example embodiment as illustrated in FIG. 2, the user interface view 250 displays a webpage for the user to select, upload and store the user content 1-N 106 using the processing parameter 202 and the user content selector 204.

The user interface view 250 displays “320*240 (For website and e-mail)” in a select size block that represents the file size selected by the user to upload the user content 1-N 106 using the processing parameter 202. The user interface view 250 also displays various images that may be uploaded by the user using the user content selector 204. The user interface view 250 enables the user to select images less than 3 MB and of only JPG/GIF/PNG types as it displays “JPG/GIF/PNG files only. 3 MB maximum file size” in the content hosting service 200. The user may store photos in the server 104 free of cost. The user content 1-N 106 (e.g., may be the digital media) may be selected (e.g., using the user content selector 204 of FIG. 2). The user content 1-N 106 may be uploaded (e.g., using the upload module 110 of FIG. 1) to the server 104 associated with the content hosting service 200. The user content 1-N 106 may be accessed using the content hosting service 200, according to the example embodiment.

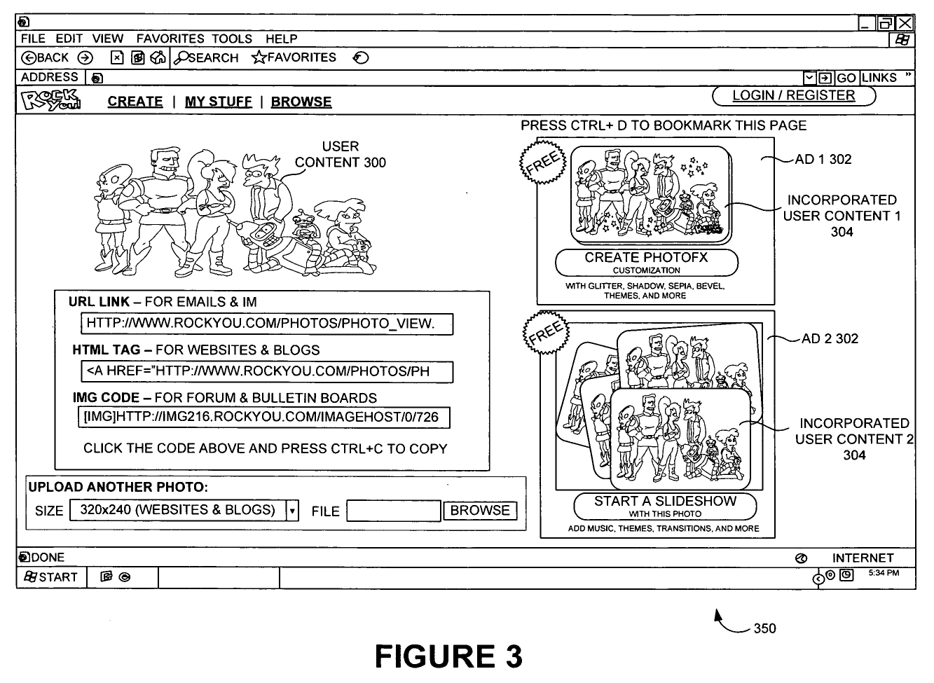

FIG. 3 is a user interface view 350 displaying advertisements 1-2 302 incorporating user content 300 on a website, according to one embodiment. Particularly, FIG. 3 illustrates the user content 300, the ads 1-2 302, and incorporated user content 1-2 304, according to one embodiment.

For example, the user content 300 may include images, audio, video, text, and/or other digital media. The ads 1-2 302 may be displayed on the website based on processing of the user content 300. As illustrated in FIG. 3, the ads 1-2 302 include representations of the user content 300 as incorporated user content 1-2 304. In other words, the ads 1-2 302 may display incorporated user content 1-2 304 in a slightly different but recognizable form from user content 300. For example, incorporated user content 1-2 304 may include rotated, scaled, cropped, color-transformed, etc., versions of user content 300.

In the example embodiment as illustrated in FIG. 3, the user interface view 350 displays ads 1-2 302, which incorporate the user content 300 uploaded by the user as incorporated user content 1-2 304. Ad 1 302 allows the user to create a photoFX customization for customizing user content 300. Ad 2 302 allows the user to create a slideshow that includes user content 300. The user interface view 350 also provides options (e.g., Universal Resource Locator (URL) link, HyperText Markup Language (HTML) tag, IMG code) for sharing the user content 300 using email, instant messaging (IM), websites, weblogs, forums, bulletin boards, etc. For example, the user content 300 may be used to generate other types of advertisements and shared via other means.

The user may also be enabled to bookmark a webpage associated with the incorporated user content 1-2 304. For example, the user may upload photos through an upload photo link. Also, the user may customize the photos and/or view the slide shows associated with the incorporated user content 1-2 304. In addition, the user may also bookmark the webpage containing the incorporated content 1-2 304 using CRTL+D keys.

The advertisement(s) 1-2 302 (e.g., displayed on the content hosting service 200 of FIG. 2) incorporating the user content 300 may be received. For example, the advertisement(s) 1-2 302 may be generated based on processing the user content 300 (e.g., through applying a facial recognition algorithm to an image).

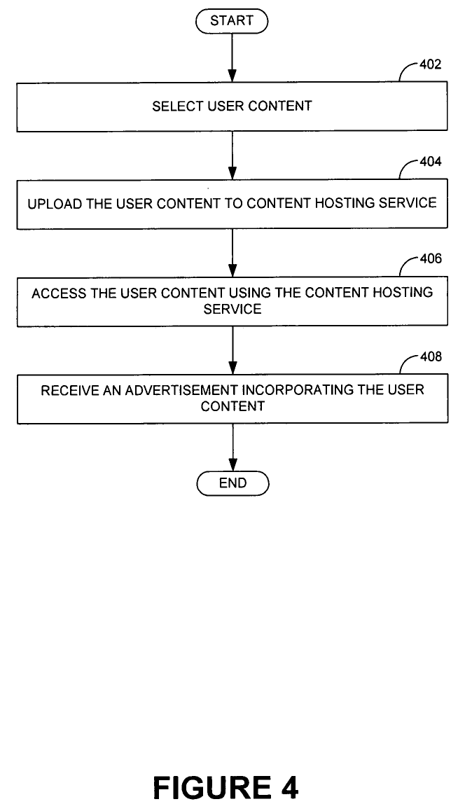

FIG. 4 is a flow chart of accessing a content hosting service (e.g., the content hosting service 200 of FIG. 2), according to one embodiment. The content hosting service 200 may reside on a server, (e.g., the server 104 of FIG. 1). In operation 402, user content (e.g., the user content 1-N 106 of FIG. 1) is selected. The user content 1-N 106 may include text, audio, video, images, etc. The selection of user content 1-N 106 may also be based on the nature of the content hosting service 200. For example, photos may be uploaded (e.g., using the upload module 110 of FIG. 1) to a photo sharing service, video to a video sharing service, text to a web blog, etc. As illustrated in FIGS. 2 and 3, the user content 1-N 106 may be selected by specifying a path to one or more files on a computer containing the user content 1-N 106. In another example embodiment, the user content 1-N 106 may be specified by dragging and dropping one or more files containing the user content 1-N 106, providing a hyperlink to a website containing the user content 1-N 106, etc. In operation 404, the user content 1-N 106 is uploaded (e.g., using the upload module 110 of user interface 102 of FIG. 1) to the content hosting service 200. The user content 1-N 106 may be uploaded using a network connection with the content hosting service 200.

In operation 406, the user content 1-N 106 (e.g., stored in the server 104 of FIG. 1) is accessed using the content hosting service 200. For example, the user may access the user content I-N 106 on a remote computer using a network connection with the content hosting service 200. The user content 1-N 106 may also be accessed by other users of the content hosting service 200. Further, the user content 1-N 106 may be accessed by an ad unit 100 to generate advertisements (e.g., the ads 1-N 108 of FIG. 1) that incorporate the user content 1-N 106. As stated above, the ad unit 100 may be a part of the same system (e.g., server 104) as the content hosting service 200, or the ad unit 100 may be implemented using a separate system. In operation 408, an advertisement (e.g., the advertisement 302 of FIG. 3) incorporating the user content 1-N 106 (e.g., uploaded by the user) is received by the user. For example, the advertisement(s) 1-N 108 incorporating a photograph uploaded by the user may be displayed to the user. The advertisement(s) 1-N 108 may be displayed (e.g., using the ad display module 112 of FIG. 1) on the content hosting service 200, or the advertisement(s) 1-N 108 may be displayed in a separate application or device. For example, the advertisement(s) 1-N 108 may be received in an email, voice mail, text message, IM, fax, etc.

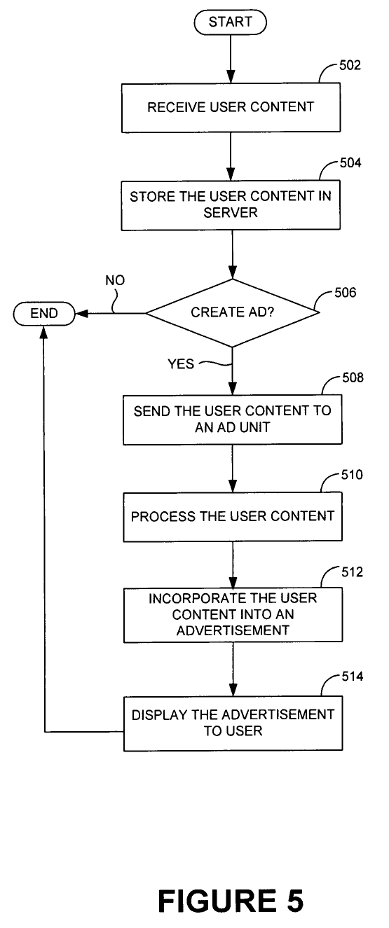

FIG. 5 is a flow chart of incorporating and displaying user content 1-N 106 in an advertisement(s) 1-N 108, according to one embodiment. In operation 502, the user content (e.g., the user content 1-N 106 of FIG. 1) is received from a user. For example, the user content 1-N 106 may include text, images, audio, video, and/or other digital media. Additionally, the user content 1-N 106 may be uploaded by the user for storage in a content hosting service (e.g., the content hosting service 200 of FIG. 2).

In operation 504, the user content 1-N 106 is stored in a server (e.g., the server 104 of FIG. 1). In one example embodiment, the server 104 may be associated with a content hosting service 200 that allows the user to access the user content 1-N 106 stored on the server 104. In operation 506, a determination is made regarding whether an ad (e.g., the ads 1-N 108 of FIG. 1) is to be created or not. For example, the ad(s) 1-N 108 may not be created if the user content 1-N 106 is of an incompatible format, too large, too small, contains irrelevant subject matter, etc. If the ad(s) 1-N 108 is not to be created, the process may be terminated. However, if the ad(s) 1-N 108 is to be created from the user content 1-N 106, the user content 1-N 106 is sent to an ad unit (e.g., the ad unit 100 of FIG. 1) in operation 508. In one example embodiment, the user content 1-N 106 may be communicated to the ad unit 100 through the server 104 associated with the content hosting service 200.

In operation 510, the user content 1-N 106 is processed. The processing may include performing one or more transformations on the user content 1-N 106, extracting information from the user content 1-N 106, etc. In addition, the processing may be performed by either the content hosting service 200 or the ad unit 100. In operation 512, the user content 1-N 106 is incorporated into an advertisement (e.g., the ads 1-N 108). For example, the ad unit 100 may incorporate the user content 1-N 106 into the advertisement(s) 1-N 108 based on the processing of the user content 1-N 106. For example, facial recognition may be performed on an image uploaded by the user. Regions of the image corresponding to identified faces may then be incorporated into an advertisement(s) 1-N 108. In operation 514, the advertisement(s) 1-N 108 is displayed (e.g., using the ad display module 112 of FIG. 1) to the user. The advertisement(s) 1-N 106 may be displayed using a variety of methods, including static text and/or images, Flash, video, audio, etc. The advertisement(s) 1-N 108 may also be printed on paper and delivered to the user using a postal service.

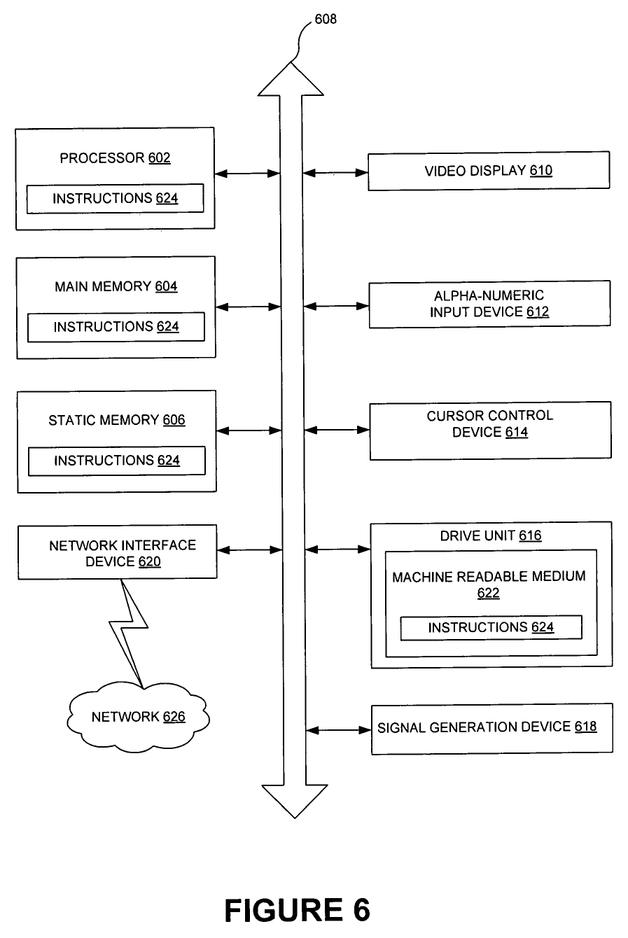

FIG. 6 is a diagrammatic system view 600 of a data processing system in which any of the embodiments disclosed herein may be performed, according to one embodiment. Particularly, the system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein may be performed. The processor 602 may be a microprocessor, a state machine, an application-specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, a keyboard and/or any other input device of text (e.g., a special device to aid the physically challenged). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one/or more operations disclosed herein.

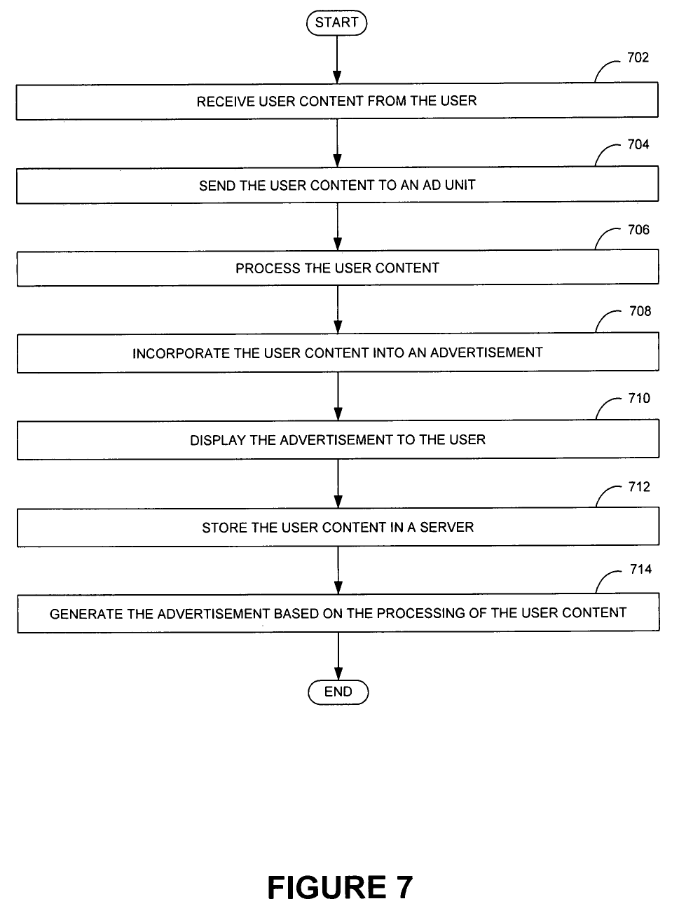

FIG. 7 is a process flow of generating an advertisement (e.g., the ads 1-2 302 of FIG. 3) associated with user content (e.g., the user content 300 of FIG. 3), according to one embodiment. In operation 702, the user content 300 may be received (e.g., using the server 104 of FIG. 1) from a user. In operation 704, the user content 300 may be sent to an ad unit (e.g., the ad unit 100 of FIG. 1). In operation 706, the user content 300 may be processed (e.g., by applying a facial recognition algorithm to an image).

In operation 708, the user content 300 may be incorporated into the advertisement(s) 1-2 302. In operation 710, the advertisement(s) 1-2 302 may be displayed (e.g., using the ad display module 112 of FIG. 1) to the user. In operation 712, the user content 300 may be stored in a server 104. In operation 714, the advertisement(s) 1-2 302 may be generated based on the processing of the user content 300 (e.g., received from the user).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated circuitry (ASIC) and/or in Digital Signal Processor (DSP) circuitry). For example, the upload module 110 and the ad display module 112, and other modules of FIGS. 1-8 may be enabled using an upload circuit and an ad display circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of advertising to a user, comprising:
receiving user content from the user;
sending the user content to an ad unit;
processing the user content;
incorporating the user content into an advertisement; and
displaying the advertisement to the user.

2. The method of claim 1, further comprising storing the user content in a server.

3. The method of claim 2, wherein the server comprises a content hosting service.

4. The method of claim 1, further comprising generating the advertisement based on the processing of the user content.

5. The method of claim 1, wherein the user content comprises digital media.

6. The method of claim 1, wherein the advertisement is displayed on a website.

7. The method of claim 1, wherein processing the user content comprises applying a facial recognition algorithm to an image.

8. A system for advertising to a user, comprising:
a server configured to receive user content from the user; and
an ad unit configured to:
process the user content,
incorporate the user content into an advertisement, and
transmit the advertisement to the user.

9. The system of claim 8, further comprising:
a user interface, comprising:
an upload module configured to obtain the user content from the user; and
an ad display module configured to display the advertisement to the user.

10. The system of claim 8, wherein the server is further configured to:
store the user content.

11. The system of claim 10, wherein the server comprises a content hosting service.

12. The system of claim 8, wherein the ad unit is further configured to generate the advertisement based on the processing of the user content.

13. The system of claim 8, wherein the user content comprises digital media.

14. The system of claim 8, wherein the advertisement is displayed on a website.

15. The system of claim 8, wherein processing the user content comprises applying a facial recognition algorithm to an image.

16. A method of accessing a content hosting service, comprising:
selecting user content;
uploading the user content to a server associated with the content hosting service;
accessing the user content using the content hosting service; and
receiving an advertisement incorporating the user content.

17. The method of claim 16, wherein the advertisement is generated based on processing of the user content.

18. The method of claim 17, wherein processing the user content comprises applying a facial recognition algorithm to an image.

19. The method of claim 16, wherein the user content comprises digital media.

20. The method of claim 16, wherein the advertisement is displayed on the content hosting service.
